(19) United States
(12) Patent Application Publication
(10) Pub. No.: US 2026/0286766 A1
(43) Pub. Date: Sep. 24, 2026

(54) INTEGRATED MECHANICAL FASTENING BETWEEN METAL PANELS AND PERIMETER FRAME

(71) Applicant: Kenneth Farrell Hepburn, Ventura, CA (US)

(72) Inventor: Kenneth Farrell Hepburn, Ventura, CA (US)

(21) Appl. No.: 19/572,502

(22) Filed: Mar. 19, 2026

Related U.S. Application Data
(60) Provisional application No. 63/775,127, filed on Mar. 20, 2025.

(51) Int. Cl. E06B 3/968

(52) U.S. Cl. CPC E06B 3/9684

(57) ABSTRACT

Systems and methods including: cutting a panel material to form a panel including one or more hooks in a first side surface of the perimeter thereof; cutting a frame material to form a frame including one or more first slots that are configured to interlock with the one or more hooks; inserting the one or more hooks into the one or more first slots; and sliding at least one of the panel and frame such that grooves formed between each of the one or more and a side surface of the panel are interlocked with the inner wall of the frame.

### CROSS-REFERENCE TO RELATED APPLICATION

This application claims the priority benefit of U.S. Provisional Patent Application Ser. No. 63/775,127 filed Mar. 20, 2025, incorporated herein by reference in its entirety.

### TECHNICAL FIELD

Embodiments relate generally to entry gates or fences, and more particularly to entry gates, or fences including panels and perimeter frames.

### BACKGROUND

Metal entry/pedestrian gates, and fences require costly, time-consuming manual layout, measurement, and welding of components to fabrication. Typical design and fabrication of steel and wrought iron gates are expensive due to high skilled labor costs and archaic fabrication methods. Manual measurement, cutting, and manual layout of components then requires extensive manual welding of components to fabricate the gate/fence panel.

### SUMMARY

A system embodiment may include: a panel including one or more hooks in the perimeter thereof; and a frame including one or more first slots configured to interlock with the one or more hooks.

In additional system embodiments, the panel includes a continuous primary surface and a first side surface, and the one or more hooks may be configured to protrude from the first side surface of the perimeter. In additional system embodiments, each hook of the one or more hooks may be configured to form a groove between the bent end of the hook and the first side surface. In additional system embodiments, the width of the first side surface of panel may be equal to the length of the side of the first tubular member, and the locations of the first slots may be configured to be aligned with the end of the groove of the panel.

In additional system embodiments, the groove of each hook of the one or more hooks may be interlocked with the inner wall of the frame by sliding the panel or the frame. In additional system embodiments, the one or more hooks includes at least one of: a curved shape, J-shaped shape, U-shaped shape, and angled end shape. In additional system embodiments, the one or more hooks, the continuous primary surface, and the first side surface may be configured as an integrated body formed by cutting a single panel material.

In additional system embodiments, the panel further comprises one or more tabs that may be configured to protrude from the second side surface of the perimeter, and the frame further comprises one or more second slot configured to receive the one or more tabs. In additional system embodiments, the frame comprises: one or more first tubular members including the one or more first slots that may be configured to interlock with the one or more hooks, and one or more second tubular members including the one or more second slots that may be configured to receive the one or more tabs.

In additional system embodiments, when the one or more hooks and the one or more first slots may be engaged with each other, the first side surface of the panel may be configured to be in contact with the side of the first tubular member. In additional system embodiments, when the one or more tabs may be received into the one or more second slots, the second sides of the panel may be configured to be in contact with the side of second tubular members.

In additional system embodiments, the ends of the first tubular members may be configured to meet the adjacent ends of the second tubular members when the first and second tubular members may be fully assembled with the panel. In additional system embodiments, each of the first and second tubular members include diagonal ends such that each end may be configured to meet the adjacent end seamlessly.

A method embodiment may include: cutting a panel material to form a panel including one or more hooks in a first side surface of the perimeter thereof; cutting a frame material to form a frame including one or more first slots that may be configured to interlock with the one or more hooks; inserting the one or more hooks into the one or more first slots; and sliding at least one of the panel and frame such that grooves formed between each of the one or more and a side surface of the panel may be interlocked with the inner wall of the frame.

In additional method embodiments, the step of cutting a panel material includes cutting the panel material to further include one or more tabs in a second side surface of the perimeter, where the step of cutting a frame material includes: cutting the frame material to further include one or more second slots that may be configured to receive the one or more tabs, and where the method further comprises: inserting the one or more tabs into the one or more second slots.

In additional method embodiments, the frame comprises first tubular members including the one or more first slots and second tubular members including the one or more second slots, and the method further comprises welding joints between the first and second tubular members.

In additional method embodiments, before the steps of cutting, further comprising modeling the system in Computer Assisted Design (CAD) software, where the step of modeling includes: modeling the panel to include the one or more hooks; and modeling the frame to include the one or more first slots, the first slots being aligned with the ends of grooves between the one or more hooks and the side of the panel. In additional system embodiments, the steps of cutting may be performed based on the modeled geometry of the panel and frame, using at least one of lasers and plasma cutting machines controlled by Computer Assisted Manufacturing (CAM) software.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts an exploded perspective view of a gate or fence system comprising a panel and a frame that are configured to be connected via integrated mechanical fastening, according to one embodiment;

FIG. 1B depicts a magnified view of a hook of a first side surface of a panel and a slot of a first tubular member that is configured to be engaged with the hook, according to one embodiment;

FIG. 1C depicts a magnified view of a tab of a second side surface of a panel and a slot of a second tubular member that is configured to receive the tab, according to one embodiment;

FIG. 2 depicts a partial exploded perspective view of a gate or fence system, according to one embodiment;

FIG. 3 depicts a perspective view of components of a gate or fence system, according to one embodiment;

FIG. 4 depicts locations of hooks and tabs on a panel and corresponding locations of slots in tubular members of a frame in a gate or fence system, according to one embodiment;

FIG. 5 depicts a magnified perspective view of a hook and a corresponding slot, according to one embodiment;

FIG. 6 depicts a partial perspective view of an assembled gate or fence system, according to one embodiment;

FIG. 7 depicts a perspective view of an assembled gate or fence system, according to one embodiment;

FIG. 8 depicts a flowchart for a method of manufacturing a gate or fence system, according to one embodiment;

FIG. 9 illustrates an example top-level functional block diagram of a computing device embodiment;

FIG. 10 shows a high-level block diagram and process of a computing system for implementing an embodiment of the system and process;

FIG. 11 shows a block diagram and process of an exemplary system in which an embodiment may be implemented; and

FIG. 12 depicts a cloud computing environment for implementing an embodiment of the system and process disclosed herein.

### DETAILED DESCRIPTION

The present system and method disclose gate or fence systems that comprise integrated mechanical fastening between the panel and the perimeter frame, which require no welding or fasteners between them and reduces overall welding requirements by 80-90%. The disclosed system and method may be utilized for gates, fences, pedestrian-vehicle barriers, architectural facades, interior-exterior space dividers, and the like.

The Integrated Mechanical Fastening between metal gate/fence panels and the metal perimeter frame allows for a rapid assembly process even by unskilled labor simply aligning and inserting the ‘hooks’ cut in the panel component into the slots cut in the frame components, and sliding the tube component into the locked/secure position which ensures the components are integrated/fastened. No manual measurement, layout, or cutting of components is required. Only the corners of the frame are then welded together, reducing the typical welding operation by approximately 80-90%.

In addition, the present method may utilize CAD (computer assisted design) and CAM (Computer Assisted Manufacturing) software and CNC (Computer Numerical Control) lasers/plasma cutting machines to consistently provide high quality product by eliminating costly and variable quality manual labor, while achieving significant time savings. Accordingly, design options are vastly increased compared to traditional fabrication methods. Skilled labor productivity can be increased by 100% to 500% or more.

In some embodiments, an average ‘in-shop’ assembly time for a 5′5″×14′8″ custom design gate/fence panel using the invention is 1.5-2.5 man hours compared to: 8-60+ hours for Fabrication/Manufacturing. This varies significantly by material and complexity.

By way of example, a simple steel tube gate (single swing, ~10 ft wide) may reuire 2-4 hours for Material prep & cutting; 4-8 hours for welding & assembly; and 2-4 hours for grinding & finishing: 2-4 hours. The total time for the construction and assembly of this simple steel tube gate may be about 8-16 hours.

By way of example, an ornamental iron gate (decorative pickets, scrollwork) may require 3-6 hours for material prep & cutting; 8-20 hours for welding & forge work: 8; and 4-8 hours for grinding, polishing & detailing. The total time for the construction and assembly of this ornamental iron gate may be about 15-34 hours.

Accordingly, the present system and method allow a user to fabricate gate/fence panels with much greater speed, efficiency, and precision compared to typical manufacturing methods. The components produced by CAD and CAM manufacturing software and CNC controlled laser/plasma cutting equipment may provide seamless, secure mechanical fastening without welding and/or separate fasteners.

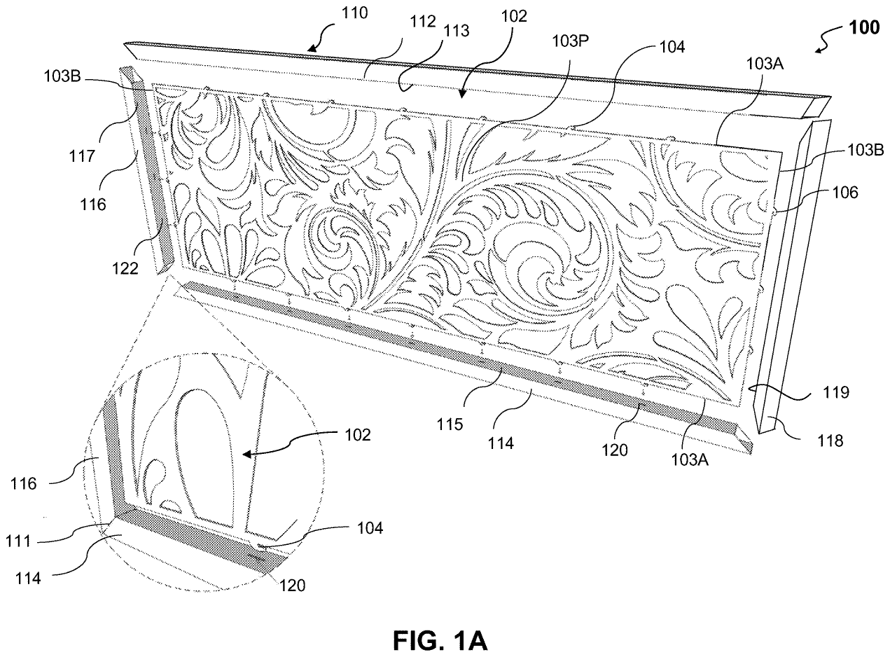

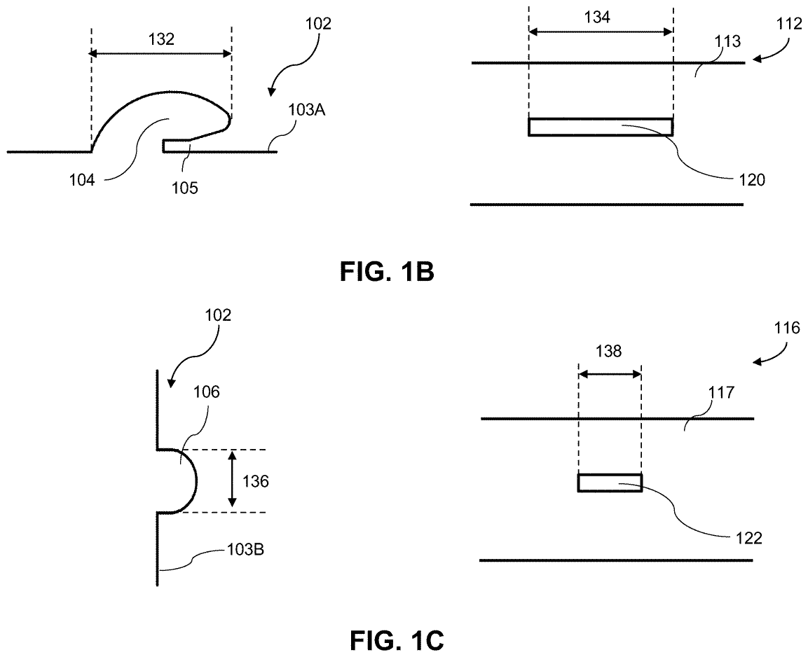

FIG. 1A depicts an exploded perspective view of a gate or fence system 100 comprising a panel and a frame that are configured to be connected via integrated mechanical fastening, according to one embodiment.

FIG. 1B depicts a magnified view of a hook 104 of a first side surface of a panel and a slot of a first tubular member that is configured to be engaged with the hook, according to one embodiment.

FIG. 1C depicts a magnified view of a tab 106 of a second side surface of a panel and a slot of a second tubular member that is configured to receive the tab, according to one embodiment.

Referring to FIGS. 1A to 1C, the system 100 comprises a panel 102 with hooks 104 and tabs 106 in the perimeter and a frame 110 with slots 120, 122 configured to interlock with the hooks 104 and tabs 106 of the panel 102.

In some embodiments, hooks may be formed on both first side 103A and second side 103B of the panel (no tabs). In other embodiments, there may be tabs only on the first side 103A and second side 103B of the panel. In some embodiments, the hooks may allow attachment/partial attachment on the sides for larger format assemblies. Any combination of hooks and tabs are possible and contemplated based on the assembly.

Specifically, the panel 102 may be a sheet or plate configured to form a solid or semi-open continuous primary surface 103P to function as a physical barrier of the gate or fence system. The panel 102 may have various shapes such as rectangular, square, but is not limited thereto. This primary surface of the panel 102 may be formed with or include holes, engraved or embossed design for decorative or other purposes as the body of the entry gate or fence system, which is exposed to outside or to pedestrians. In some embodiments, the panel 102 may be approximately 1/16″ to ½″+ thick metal but is not limited thereto. The panel 102 may be made of various materials such as metal, steel, stainless steel, aluminum, fiberglass, Polyvinyl chloride (PVC), polycarbonate, cement board, wood, carbon fiber, cross-laminated-timber other material, and combinations thereof (e.g., layered materials, composite structure, assembled parts made of different materials, and others) according to desired performance and/or application requirements. The structural integrity and strength of the panel 102 may be reinforced by the frame 110 that is configured to support or surround at least some of edge or perimeter of the panel 102. In some embodiments, the thickness of the panel 102 may be larger than the thickness of the frame 110.

The panel 102 may comprise one or more hooks formed on one or both first sides 103A extended in parallel and/or one or more tabs 106 formed on one or both second sides 103B extended in parallel. The second sides 103B may be perpendicular to the first sides 103A. In some embodiments, the hooks may be formed on the first sides 103A, which is longer than the second sides 103B, and may be provided in a greater number than the tabs formed in the second sides 103B to increase structural engagement strength between the panel 102 and frame 110. This structure allows more interlocking between the individual hooks of panel 102 and slots of the frame 110 and also enables hook engagement between the panel 102 and a bigger portion of the frame 110.

As shown in FIG. 1B, the hook may protrude from the first side surface103A and have a bent end, which is configured to form a narrow groove 105 between the bent end of the hook and the first or second side surface103A, 103B. The bent end of the hook may include a curved, J-shaped, U-shaped, or angled end. As shown in FIG. 1C, The tab may protrude from the second sides 103B and have various shapes such as round, square, rectangular, and others. In some embodiments, the ‘tabs’ on the sides may be hooks, ‘partial hooks’, or a combination of hooks and tabs on sides for larger size panels.

The frame 110 may comprise at least one frame part (e.g., tubular member) configured to support at least one perimeter or edge of the panel 102. In an embodiment shown in FIG. 1, the frame 110 may comprise four tubular members 112, 114, 116, 118 that are configured to surround the four sides 103A, 103B of the panel 102. The first tubular members 112, 114 may be configured to support the first sides 103A of the panel 102 and include first slots 120 that are configured to receive and interlock with the corresponding hooks of the panel 102. Accordingly, the width 134 of the first slot 120 may be equal to or slightly larger than the width 132 of the hook. When the hook is entered through the first slot 120 of the first tubular member 112 or 114, the first tubular member 112 or 114 may then be slid in a direction opposite to the bent direction of the hook so that the narrow groove 105 formed by the bent end of the hook is interlocked with the wall of the first tubular member 112 or 114. Once the hooks of the first sides 103A of the panel 102 and the first slot 120 of the first tubular member 112 or 114 are engaged with each other, the first sides 103A of the panel 102 and the side 113 of the first tubular member 112 or 114 may form a seamless structure.

The second tubular members 116, 118 may be configured to support the second sides 103B of the panel 102 and include second slots 122 that are configured to receive the corresponding tabs of the panel 102. When the first tubular members 112, 114 and the panel 102 form a seamless structure, the sides 117 of second tubular members 116, 118 may be configured to be assembled with the second sides 103B of the panel 102 10, receiving the tabs 106 of the panel 102 through the slots 122. The second sides 103B of the panel 102 10 and the sides 117 of second tubular members 116, 118 may be in contact and also form a seamless structure.

The first tubular members 112, 114 may include ends that meet the adjacent ends of the second tubular members 116, 118 when the first and second tubular members (112, 114, 116, 118) are fully assembled with the panel (102). In some embodiments, each end of the first tubular members 112, 114 and each end of the second tubular members 116, 118 may be configured to have a diagonal end or mitered end such that when the panel 102 102, the first tubular members 112, 114, and the second tubular members 116, 118 are fully assembled, each end may meet the adjacent end seamlessly, forming a continuous perimeter without gaps. The joints 111 between each end of the first tubular members 112, 114 and each end of the second tubular members 116, 118 may be welded or fixed using fasteners. Each of the four sides of the photo frame has a diagonal (or mitered) end, configured to meet

In some embodiments, the tubular members 112, 114, 116, 118 of the frame 110 may be I-beam and have angle profile. In some embodiments, the cross section of the frame 110 may have round or any polygonal shape such as square, rectangular, or others. The panel 102 may be made of various materials such as metal, steel, other material, and combination thereof (e.g., composite structure, assembled parts made of different materials, and others) according to desired performance and/or application requirements. In some embodiments, the panel 102 may be made of various materials such as metal, steel, stainless steel, aluminum, fiberglass, PVC, polycarbonate, cement board, wood, carbon fiber, cross-laminated-timber, other materials, and combination thereof (e.g., layered materials, composite structure, assembled parts made of different materials, and others).

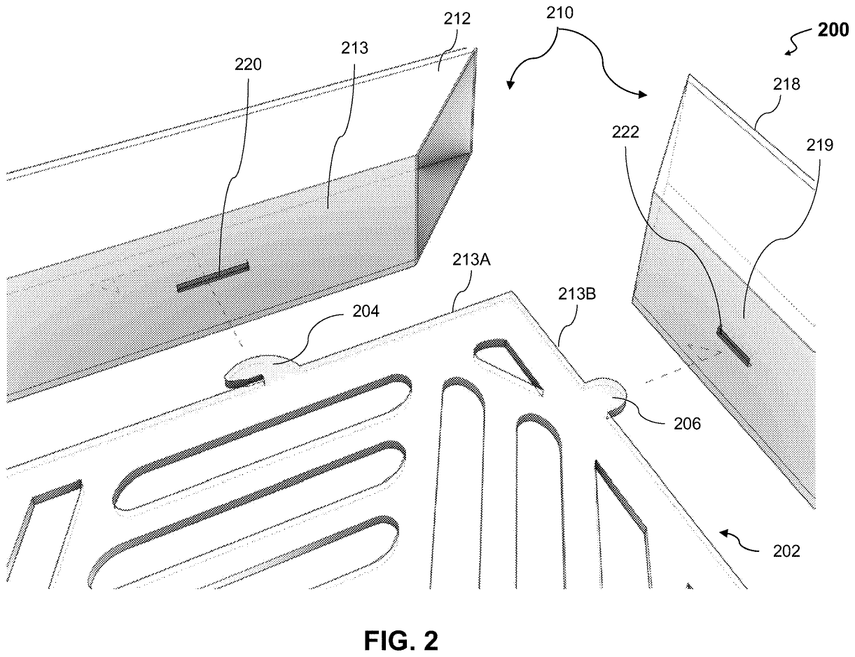

FIG. 2 depicts a partial exploded perspective view of a gate or fence system, according to one embodiment. The system 200 shown in FIG. 2 may have a similar structure to the system 100 shown in FIG. 1A as described above. Referring to FIG. 2, the system 200 comprises a panel 202 with hooks 204 and tabs 206 and a frame 210 with slots 120, 122 that are configured to interlock with the hooks 204 and tabs 206.

The hook 204 formed on the first side surface 213A of the panel 202 may be configured to be received through the slot 220 formed in the side 213 of the first tubular member 212 and then interlocked with the inner wall of the first tubular member 212 by sliding the panel 202 in a direction the hook 204 is bent or by sliding the first tubular member 212 in a direction opposite to the bent direction. The tab 206 formed on the second side surface 213B of the panel 202 may be configured to be received through the slot 222 formed in the side 219 of the second tubular member 218.

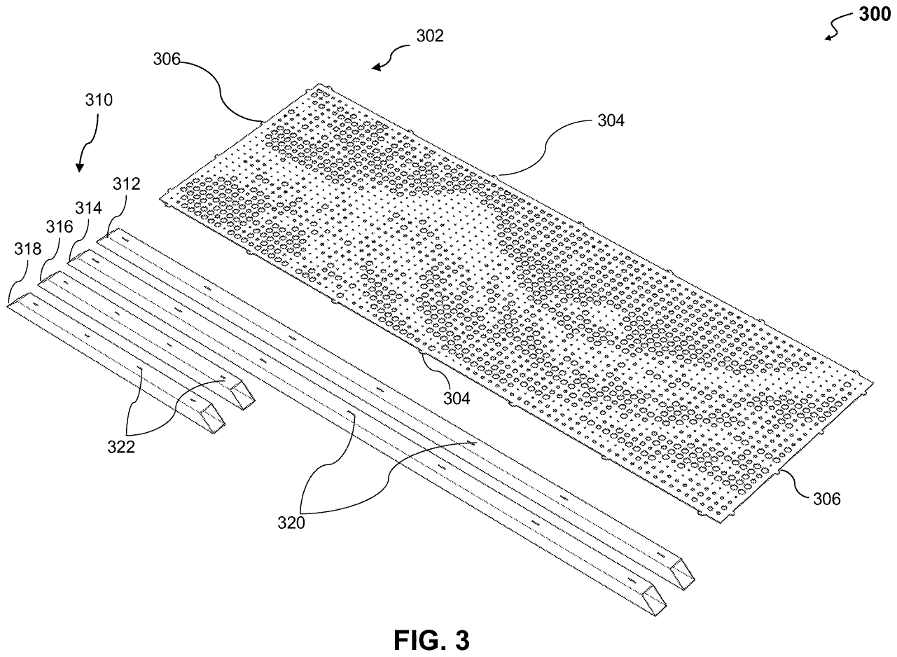

FIG. 3 depicts a perspective view of components of a gate or fence system, according to one embodiment. Referring to FIG. 3, the system 300 may comprise a panel 302 and a frame 310 including two first tubular members 312, 314 and two second tubular members 316, 318. The panel 302 may be a rectangular shape having the longer sides with hooks 304 and shorter sides with tabs 306. The longer sides of the panel 302 may be interlocked with the first tubular members 312, 314 via engagement between the hooks 304 and slots 320 while the shorter sides of the panel 302 may be assembled with the second tubular members 316, 318 via entering the tabs 306 into the slots 322.

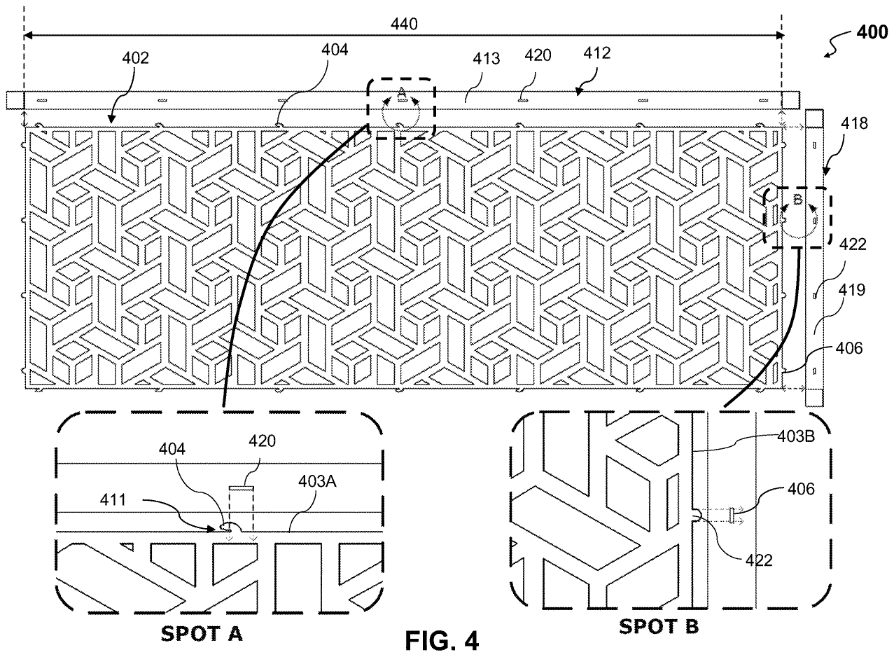

FIG. 4 depicts locations of hooks and tabs on a panel and corresponding locations of slots in tubular members of a frame in a gate or fence system, according to one embodiment. Referring to FIG. 4, the width of the first side surface403A of panel 402 may be equal to the length 440 of the side 413 of the first tubular member 412. The width of the slot 420 of the first tubular member 412 may be equal to the width of the hook 404, but the locations of the slots 420 of the first tubular member 412 may be configured to be aligned with the end of an optional narrow groove formed between the corresponding hook 404 and the first side surface 403A of the panel 402. Meanwhile, the width of the second side surface403B of panel 402 may be equal to the length of the side 419 of second tubular member 412. The width of the slot 422 of the second tubular member 418 may be equal to the width of the tab 406, and the locations of the slots 422 of the second tubular member 418 may be configured to be aligned with the locations of the corresponding tabs 406.

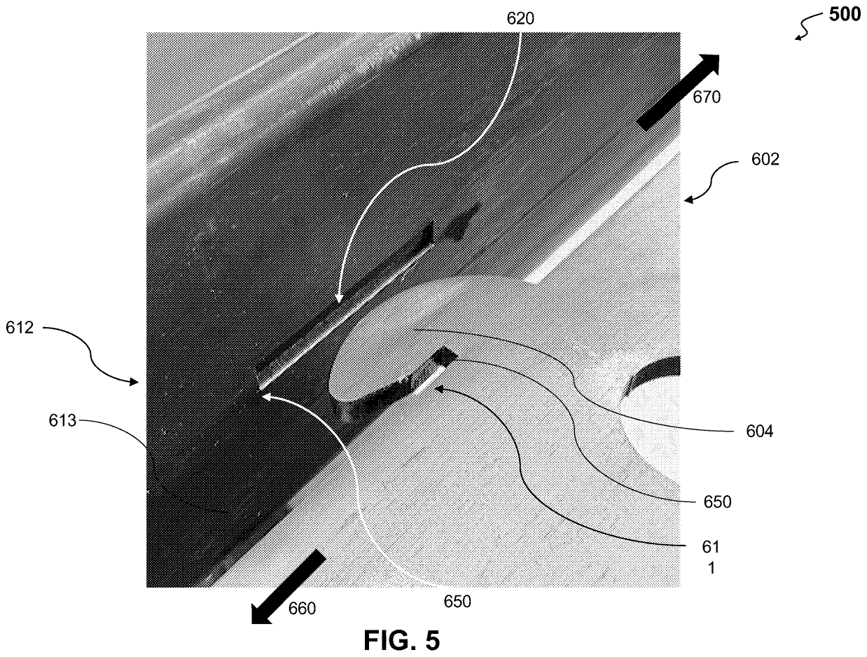

FIG. 5 depicts a magnified perspective view of a hook and a corresponding slot, according to one embodiment. Referring to FIG. 5, the hook 604 formed on the side of the panel 602 may be configured to be received through the slot 620 formed in the side 613 of the tubular member 612 and then interlocked with the inner wall 650 of the tubular member 612 by sliding the panel 602 in a direction 660 the hook 604 is bent or by sliding the tubular member 612 in a direction 670 opposite to the bent direction.

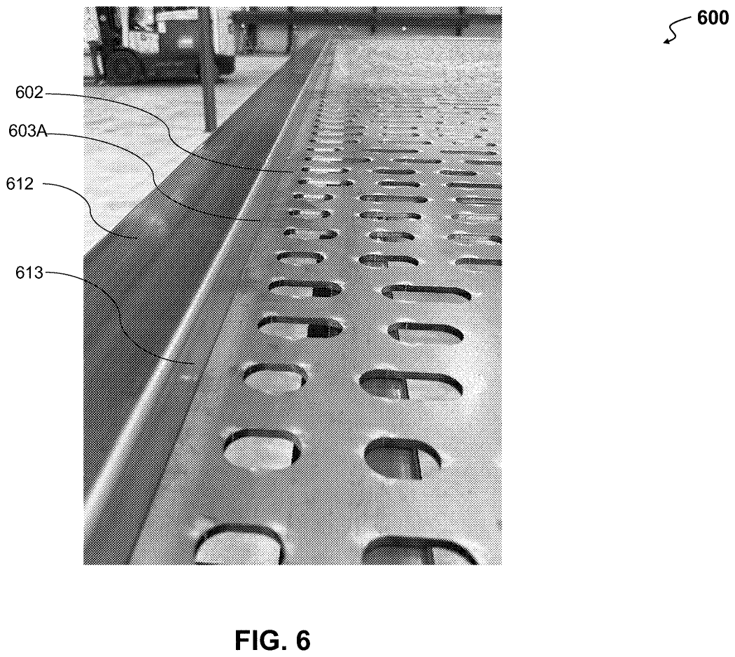

FIG. 6 depicts a partial perspective view of an assembled gate or fence system, according to one embodiment. Referring to FIG. 6, the system 600 may be configured to be assembled via interlocking between hooks (not shown) of a side 603A of a panel 602 and slots (not shown) of a side 613 of a tubular member 612, and the side 603A of the panel 602 and the side 613 of the tubular member 612 may form a seamless structure.

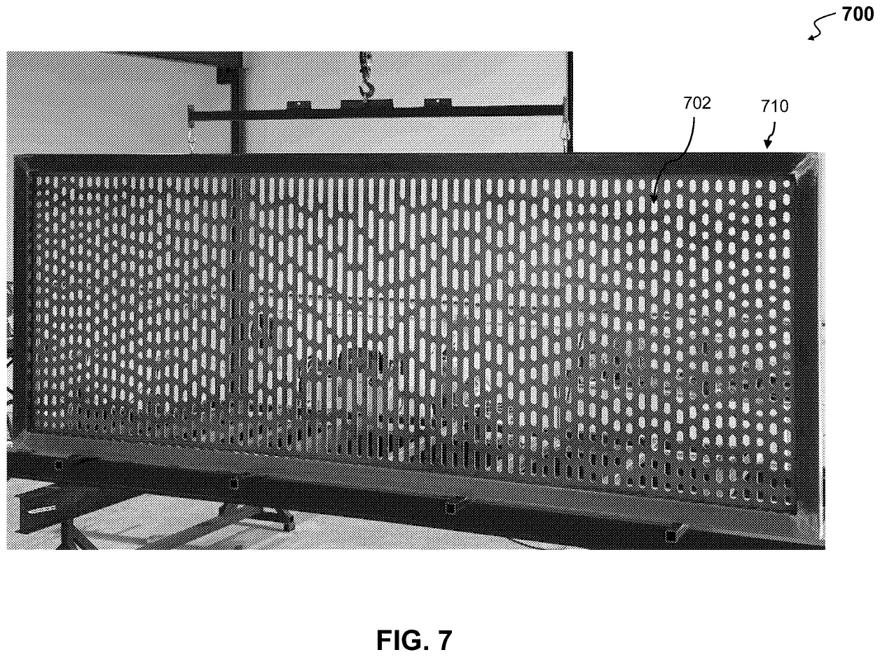

FIG. 7 depicts a perspective view of an assembled gate or fence system, according to one embodiment. Referring to FIG. 7, the system 700 provides a seamless structure between a panel 702 and a frame 710 without welding. In some embodiments, the joints of tubular members of the frame may be welded.

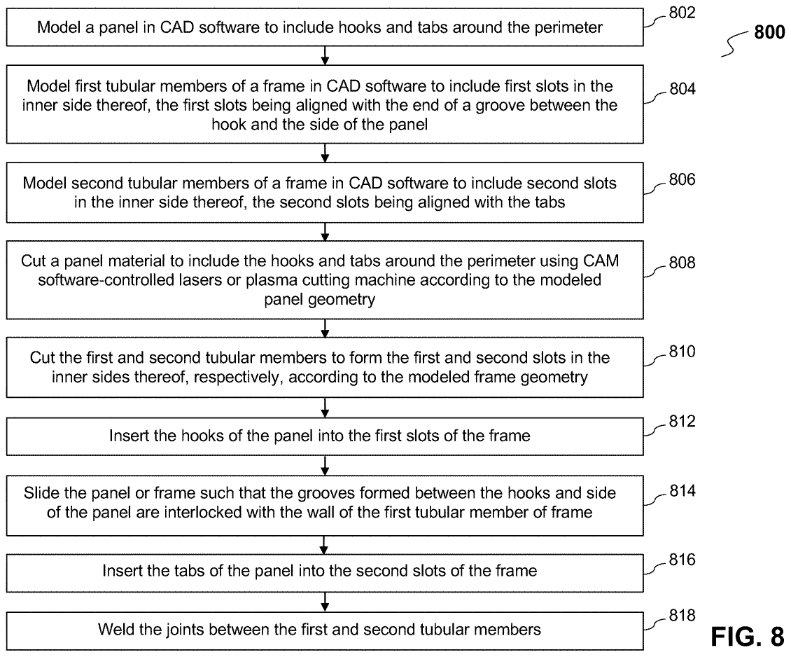

FIG. 8 depicts a flowchart for a method of manufacturing a gate or fence system, according to one embodiment. The present method may utilize CAD (computer assisted design) and CAM (Computer Assisted Manufacturing) software to integrate the hook, tab and slot mechanical fastening into the frame and panel components.

In some embodiments, a Parametric Modeling Configurator is used to automate the CAD/CAM processes to produce ‘cut-ready’ files in DXF and STEP formats for processing panel and tube components. Referring to FIG. 8, the method 800 may start with creating the mechanical interlocking design for both panel (e.g., sheet or plate) and perimeter frame (e.g., tubular member) using CAD software in DXF files. The panel may be modeled in CAD software to include hooks and tabs around perimeter thereof to be cut with at least one of laser and plasma (step 802). Likewise, the frame components may be modeled in CAD software to include slots in the sides of tubular members of the frame such that the slots are laser-cut into the tubular members. Specifically, the first tubular members of the frame may be modeled in CAD software to include first slots in the inner side thereof. In this case, the first slots may be aligned with the end of a groove between the hook and the side of the panel (step 804). The second tubular members of the frame may also be modeled in CAD software to include second slots in the inner side thereof. In this case, the second slots may be aligned with the tabs (step 806). These first and second slots may be configured to receive the hooks and tabs in the panel to interlock mechanically.

Then, CAM software may be needed to control the laser and/or plasma cutting equipment to cut the panel material and the frame material based on the modeled geometry and test tolerances for assembly. Using CAM software-controlled lasers or plasma cutting machines, the panel material (e.g., metal plate or metal sheet) may be cut with hooks and tabs around the perimeter which interlock with slots that are cut in the frame (step 808), and the frame material (e.g., first and second tubular members) may be cut to form the first and second slots in the inner sides thereof (step 810). This may create a structurally secure connection between the panel and frame while eliminating manual measurement, layout, and welding or fastening.

Then, the manufactured panel with hooks and tabs and frame with slots may be assembled by aligning and inserting the hooks and tabs of the panel into slots cut in tubular member. Specifically, the hooks of the panel may be inserted into the first slots of first tubular member of the frame (step 812), and then at least one of the panel or frame may be slid such that the grooves formed between the hooks and side of the panel are interlocked with the wall of the first tubular member of the frame (step 814). Then, the tabs of the panel may be inserted into the second slots of second tubular member of the frame (step 816). The joints between the first and second tubular members of the frame may be welded (step 818).

The present disclosure differs from the conventional system and methods in that hooks and taps of the panel are engaged with slots of the frame seamlessly without welding. The increased efficiency of the design and process provides a 100% to 500% increase in the productivity of a skilled fabricator. Additionally, our process provides a more pleasing, seamless visual design with greater structural integrity for less cost than traditional gate/fence manufacturing methods.

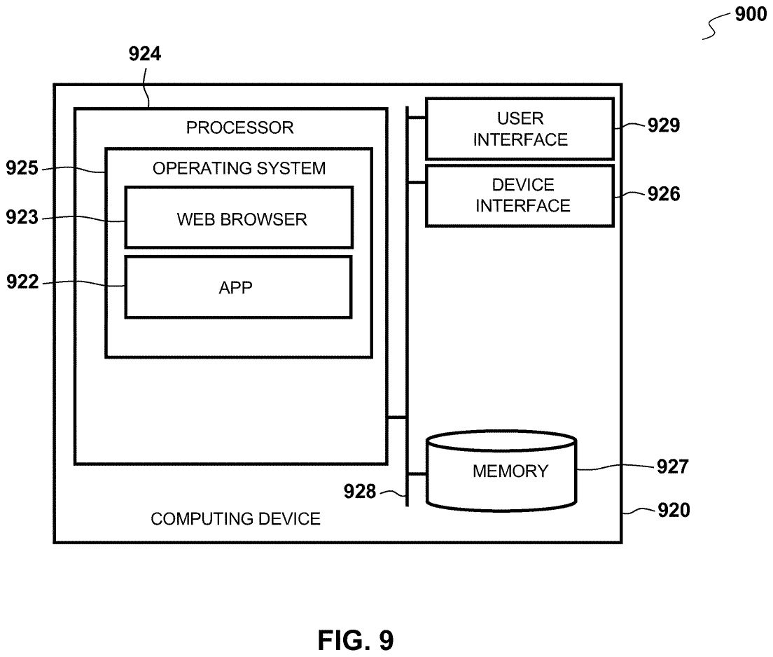

FIG. 9 illustrates an example of a top-level functional block diagram of a computing device embodiment 900. The example operating environment is shown as a computing device 920 comprising a processor 924, such as a central processing unit (CPU), addressable memory 927, an external device interface 926, e.g., an optional universal serial bus port and related processing, and/or an Ethernet port and related processing, and an optional user interface 929, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 928. In some embodiments, via an operating system 925 such as one supporting a web browser 923 and applications 922, the processor 924 may be configured to execute steps of a process establishing a communication channel and processing according to the embodiments described above.

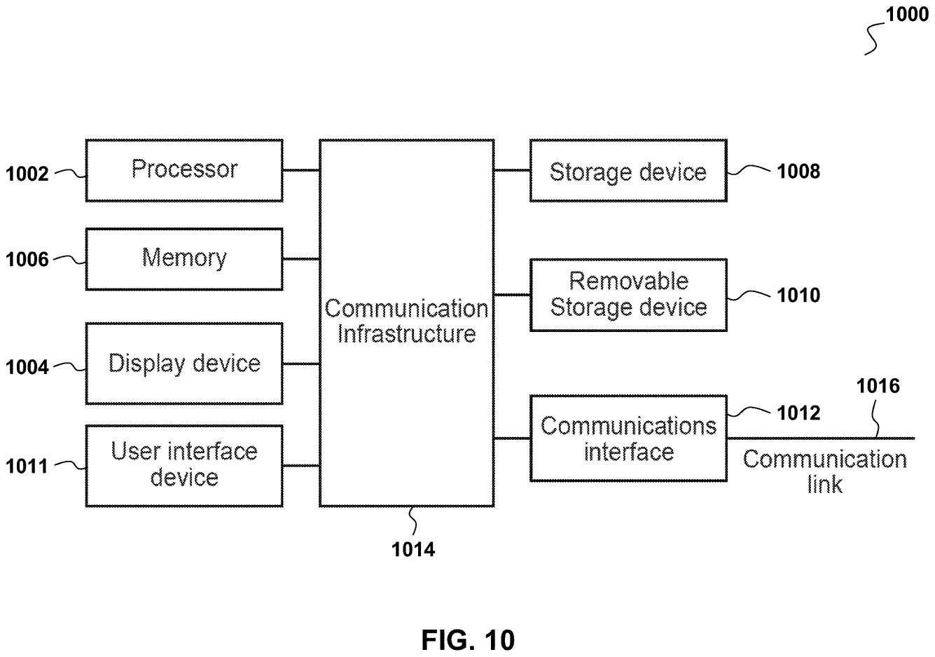

FIG. 10 is a high-level block diagram 1000 showing a computing system comprising a computer system useful for implementing an embodiment of the system and process, disclosed herein. Embodiments of the system may be implemented in different computing environments. The computer system includes one or more processors 1002, and can further include an electronic display device 1004 (e.g., for displaying graphics, text, and other data), a main memory 1006 (e.g., random access memory (RAM)), storage device 1008, a removable storage device 1010 (e.g., removable storage drive, a removable memory module, a magnetic tape drive, an optical disk drive, a computer readable medium having stored therein computer software and/or data), user interface device 1011 (e.g., keyboard, touch screen, keypad, pointing device), and a communication interface 1012 (e.g., modem, a network interface (such as an Ethernet card), a communications port, or a PCMCIA slot and card). The communication interface 1012 allows software and data to be transferred between the computer system and external devices. The system further includes a communications infrastructure 1014 (e.g., a communications bus, cross-over bar, or network) to which the aforementioned devices/modules are connected as shown.

Information transferred via communications interface 1014 may be in the form of signals such as electronic, electromagnetic, optical, or other signals capable of being received by communications interface 1014, via a communication link 1016 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1012. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

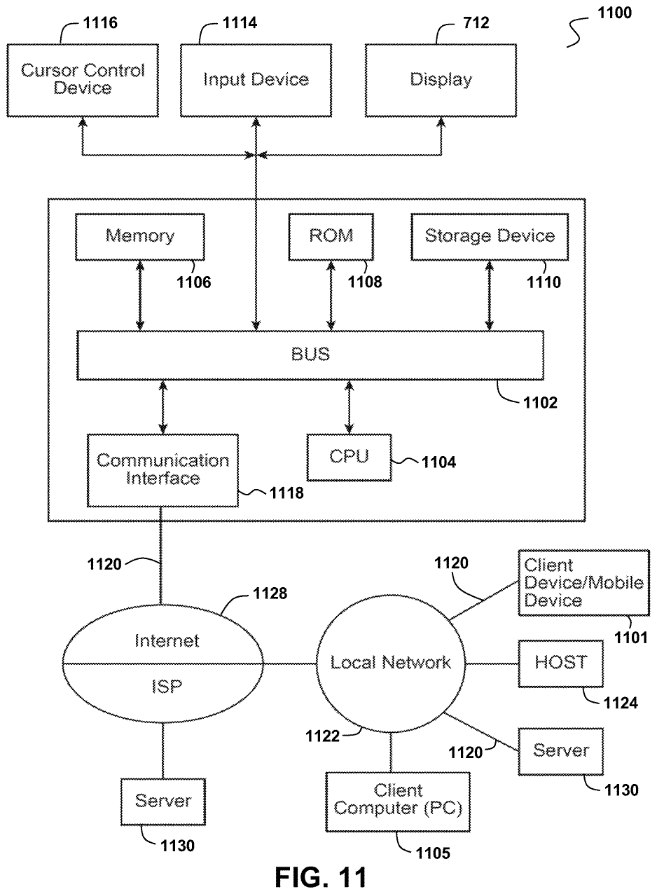

FIG. 11 shows a block diagram of an example system 1100 in which an embodiment may be implemented. The system 1100 includes one or more client devices 1101 such as consumer electronics devices, connected to one or more server computing systems 1130. A server 1130 includes a bus 1102 or other communication mechanism for communicating information, and a processor (CPU) 1104 coupled with the bus 1102 for processing information. The server 1130 also includes a main memory 1106, such as a random access memory (RAM) or other dynamic storage device, coupled to the bus 1102 for storing information and instructions to be executed by the processor 1104. The main memory 1106 also may be used for storing temporary variables or other intermediate information during execution or instructions to be executed by the processor 1104. The server computer system 1130 further includes a read only memory (ROM) 1108 or other static storage device coupled to the bus 1102 for storing static information and instructions for the processor 1104. A storage device 1110, such as a magnetic disk or optical disk, is provided and coupled to the bus 1102 for storing information and instructions. The bus 1102 may contain, for example, thirty-two address lines for addressing video memory or main memory 1106. The bus 1102 can also include, for example, a 32-bit data bus for transferring data between and among the components, such as the CPU 1104, the main memory 1106, video memory and the storage 1110. Alternatively, multiplex data/address lines may be used instead of separate data and address lines.

The server 1130 may be coupled via the bus 1102 to a display 1112 for displaying information to a computer user. An input device 1114, including alphanumeric and other keys, is coupled to the bus 1102 for communicating information and command selections to the processor 1104. Another type or user input device comprises cursor control 1116, such as a mouse, a trackball, or cursor direction keys for communicating direction information and command selections to the processor 1104 and for controlling cursor movement on the display 1112.

According to one embodiment, the functions are performed by the processor 1104 executing one or more sequences of one or more instructions contained in the main memory 1106. Such instructions may be read into the main memory 1106 from another computer-readable medium, such as the storage device 1110. Execution of the sequences of instructions contained in the main memory 1106 causes the processor 1104 to perform the process steps described herein. One or more processors in a multi-processing arrangement may also be employed to execute the sequences of instructions contained in the main memory 1106. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1104 for execution. Such a medium may take many forms, including but not limited to, non-volatile media, volatile media, and transmission media. Non-volatile media includes, for example, optical or magnetic disks, such as the storage device 1110. Volatile media includes dynamic memory, such as the main memory 1106. Transmission media includes coaxial cables, copper wire and fiber optics, including the wires that comprise the bus 1102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1104 for execution. For example, the instructions may initially be carried on a magnetic disk of a remote computer. The remote computer can load the instructions into its dynamic memory and send the instructions over a telephone line using a modem. A modem local to the server 1130 can receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1106, from which the processor 1104 retrieves and executes the instructions. The instructions received from the main memory 1106 may optionally be stored on the storage device 1110 either before or after execution by the processor 1104.

The server 1130 also includes a communication interface 1118 coupled to the bus 1102. The communication interface 1118 provides a two-way data communication coupling to a network link 1120 that is connected to the world wide packet data communication network now commonly referred to as the Internet 1128. The Internet 1128 uses electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

In another embodiment of the server 1130, interface 1118 is connected to a network 1122 via a communication link 1120. For example, the communication interface 1118 may be an integrated services digital network (ISDN) card or a modem to provide a data communication connection to a corresponding type of telephone line, which can comprise part of the network link 1120. As another example, the communication interface 1118 may be a local area network (LAN) card to provide a data communication connection to a compatible LAN. Wireless links may also be implemented. In any such implementation, the communication interface 1118 sends and receives electrical electromagnetic or optical signals that carry digital data streams representing various types of information.

The network link 1120 typically provides data communication through one or more networks to other data devices. For example, the network link 1120 may provide a connection through the local network 1122 to a host computer 1124 or to data equipment operated by an Internet Service Provider (ISP). The ISP in turn provides data communication services through the Internet 1128. The local network 1122 and the Internet 1128 both use electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

The server 1130 can send/receive messages and data, including e-mail, program code, through the network, the network link 1120 and the communication interface 1118. Further, the communication interface 1118 can comprise a USB/Tuner and the network link 1120 may be an antenna or cable for connecting the server 1130 to a cable provider, satellite provider or other terrestrial transmission system for receiving messages, data and program code from another source.

The example versions of the embodiments described herein may be implemented as logical operations in a distributed processing system such as the system 1100 including the servers 1130. The logical operations of the embodiments may be implemented as a sequence of steps executing in the server 1130, and as interconnected machine modules within the system 1100. The implementation is a matter of choice and can depend on performance of the system 1100 implementing the embodiments. As such, the logical operations constituting said example versions of the embodiments are referred to for e.g., as operations, steps or modules.

Similar to a server 1130 described above, a client device 1101 can include a processor, memory, storage device, display, input device and communication interface (e.g., e-mail interface) for connecting the client device to the Internet 1128, the ISP, or LAN 1122, for communication with the servers 1130.

The system 1100 can further include computers (e.g., personal computers, computing nodes) 1105 operating in the same manner as client devices 1101, where a user can utilize one or more computers 1105 to manage data in the server 1130.

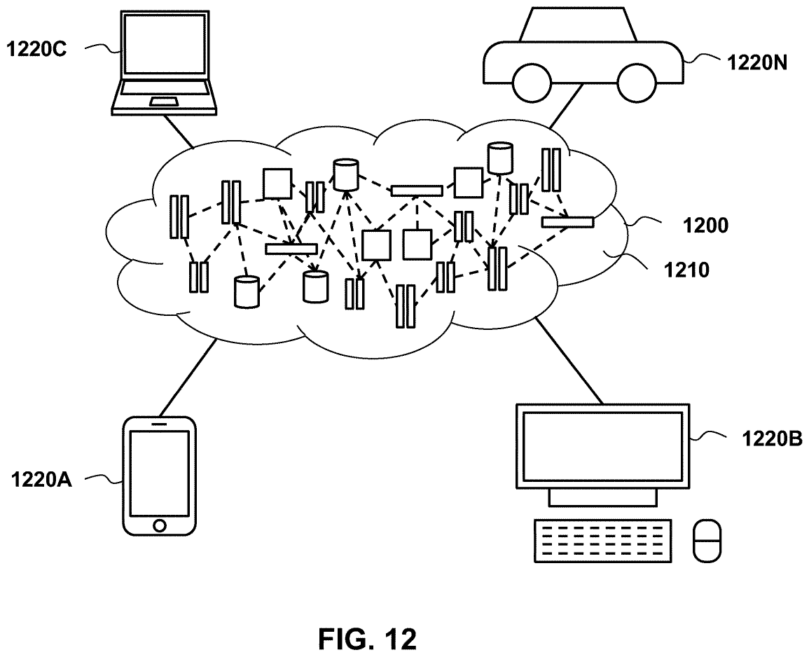

Referring now to FIG. 12, illustrative cloud computing environment 1200 is depicted. As shown, cloud computing environment 1200 comprises one or more cloud computing nodes 1210 with which local computing devices used by cloud consumers, such as, for example, personal digital assistant (PDA), smartphone, smart watch, set-top box, video game system, tablet, mobile computing device, or cellular telephone 1220A, desktop computer 1220B, laptop computer 1220C, and/or automobile computer system 1220N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 1220A-N shown in FIG. 10 are intended to be illustrative only and that computing nodes 1210 and cloud computing environment 1200 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a panel including one or more hooks in the perimeter thereof; and
a frame including one or more first slots configured to interlock with the one or more hooks.

2. The system of claim 1, wherein the panel includes a continuous primary surface and a first side surface, and
wherein the one or more hooks are configured to protrude from the first side surface of the perimeter.

3. The system of claim 2, wherein each hook of the one or more hooks is configured to form a groove between the bent end of the hook and the first side surface.

4. The system of claim 3, wherein the width of the first side surface of panel is equal to the length of the side of the first tubular member, and
wherein the locations of the first slots is configured to be aligned with the end of the groove of the panel.

5. The system of claim 3, wherein the groove of each hook of the one or more hooks is interlocked with the inner wall of the frame by sliding the panel or the frame.

6. The system of claim 3, wherein the one or more hooks includes at least one of: a curved shape, J-shaped shape, U-shaped shape, and angled end shape.

7. The system of claim 2, wherein the one or more hooks, the continuous primary surface, and the first side surface are configured as an integrated body formed by cutting a single panel material.

8. The system of claim 1, wherein the panel further comprises one or more tabs that is configured to protrude from the second side surface of the perimeter, and
wherein the frame further comprises one or more second slot configured to receive the one or more tabs.

9. The system of claim 8, wherein the frame comprises:
one or more first tubular members including the one or more first slots that are configured to interlock with the one or more hooks, and
one or more second tubular members including the one or more second slots that are configured to receive the one or more tabs.

10. The system of claim 9, wherein when the one or more hooks and the one or more first slots are engaged with each other, the first side surface of the panel is configured to be in contact with the side of the first tubular member.

11. The system of claim 10, wherein when the one or more tabs are received into the one or more second slots, the second sides of the panel is configured to be in contact with the side of second tubular members.

12. The system of claim 9, wherein the ends of the first tubular members are configured to meet the adjacent ends of the second tubular members when the first and second tubular members are fully assembled with the panel.

13. The system of claim 9, wherein each of the first and second tubular members include diagonal ends such that each end is configured to meet the adjacent end seamlessly.

14. A method comprising:
cutting a panel material to form a panel including one or more hooks in a first side surface of the perimeter thereof;
cutting a frame material to form a frame including one or more first slots that are configured to interlock with the one or more hooks;
inserting the one or more hooks into the one or more first slots; and
sliding at least one of the panel and frame such that grooves formed between each of the one or more and a side surface of the panel are interlocked with the inner wall of the frame.

15. The method of claim 14, wherein the step of cutting a panel material includes cutting the panel material to further include one or more tabs in a second side surface of the perimeter,
wherein the step of cutting a frame material includes: cutting the frame material to further include one or more second slots that are configured to receive the one or more tabs, and
wherein the method further comprises: inserting the one or more tabs into the one or more second slots.

16. The method of claim 14, wherein the frame comprises first tubular members including the one or more first slots and second tubular members including the one or more second slots, and
wherein the method further comprises welding joints between the first and second tubular members.

17. The method of claim 14, before the steps of cutting, further comprising modeling the system in Computer Assisted Design (CAD) software,
wherein the step of modeling includes:
modeling the panel to include the one or more hooks; and
modeling the frame to include the one or more first slots, the first slots being aligned with the ends of grooves between the one or more hooks and the side of the panel.

18. The method of claim 14, wherein the steps of cutting are performed based on the modeled geometry of the panel and frame, using at least one of lasers and plasma cutting machines controlled by Computer Assisted Manufacturing (CAM) software.
